(19) United States
(12) Patent Application Publication
(10) Pub. No.: US 2007/0279585 A1
(43) Pub. Date: Dec. 6, 2007

(54) ARTIFICIAL LENS, IN PARTICULAR A CONTACT OR INTRAOCULAR LENS, FOR CORRECTING PRESBYOPIA, POSSIBLY ASSOCIATED WITH OTHER VISUAL DEFECTS, AND RELATIVE PRODUCTION METHOD

(75) Inventor: Franco Bartoli, Torino (IT)

Correspondence Address: SUGHRUE MION, PLLC, 2100 PENNSYLVANIA AVENUE, N.W., SUITE 800, WASHINGTON, DC, 20037, US

(73) Assignees: STUDIO BOL DI GIUSEPPE BOLLINI, Viganello (CH); ALVARO COGLIATI, Milano (IT)

(21) Appl. No.: 11/752,490

(22) Filed: May 23, 2007

(30) Foreign Application Priority Data
Nov. 21, 2005 (IB) PCT/IB05/03473
Nov. 23, 2004 (IT) TO2004A000825

(51) Int. Cl. G02C 7/04

(52) U.S. Cl. 351/161

(57) ABSTRACT

An artificial lens (1) (contact lens or intraocular lens) for correcting presbyopia, possibly associated with other refractive defects, has at least one region (5) having a fourth-order spherical aberration in OSA notation greater than −1.5 μm and less than zero μm, and possibly associated with a basic vertex power for correcting refractive defects, and with higher-order aberrations for improving vision acuity. The lens is produced by ablating a surface of a base body of the lens by means of an appropriately controlled laser device, and according to a given photoablative pattern to induce the desired aberration.

This is a Continuation of International Application PCT/IB2005/003473, with an International Filing Date of Nov. 21, 2005, which was published under PCT Article 21(2) in English.

### TECHNICAL FIELD

The present invention relates to an artificial lens (contact or intraocular lens) for correcting presbyopia, possibly associated with other (specifically, refractive) visual defects, and to a method of producing artificial lenses.

### BACKGROUND ART

Presbyopia is a common visual defect, particularly over the age of 40-45, substantially caused by diminished accommodation of the eye, and tends to worsen with age.

Though normally corrected using eyeglasses, presbyopia is also known to be corrected using contact and intraocular lenses.

Eyeglasses, in fact, are not always popular, not only for aesthetic reasons, but also, as frequently happens, when presbyopia is associated with other visual defects, which call for the use of multifocal-lens eyeglasses (frequently not tolerated) or different eyeglasses for different activities.

Known contact and intraocular lenses for correcting presbyopia are normally multifocal lenses with concentric optical regions varying gradually in vertex power. The central region is normally for near sight and of greater curvature, and, outwards of the centre, the curvature decreases until the vertex power is that of long sight. Various concentric optical regions are sometimes provided, decreasing in curvature from the centre to the periphery of the lens.

Lenses with concentric optical regions of different vertex power are described, for example, in the following patents:
WO9941633 “A progressive multifocal contact lens suitable for compensating presbyopia”;
U.S. Pat. No. 4,418,991 “Presbyopic contact lens”;
GB2288033 “Contact lens having aspherical and annular spherical lens”:
EP0201231 “Method of treating presbyopia with concentric bifocal contact lenses”;
U.S. Pat. No. 4,752,123 “Concentric bifocal contact lens with two distance power regions”;
GB2139375 “Continuously variable contact lens”;
U.S. Pat. No. 5,805,260 “Combined multifocal toric lens design”;
EP0982618 “Presbyopia correction contact lens”;
EP0742465 “Multifocal contact lenses”;
US20030123024 “Contact lens and process for fitting”;
U.S. Pat. No. 5,771,088 “Contact lens designed to accommodate and correct for the effect of presbyopia”.

The following patents describe specific lens profiles in terms of vertex power:
WO8911672 “A progressive eccentricity multifocal contact lens and manufacturing process thereof”;
U.S. Pat. No. 6,145,987 “Multifocal ophthalmic lenses with spherical aberration varying with the addition and the ametropia”;
WO2004068214 “Ophthalmic lenses”;
U.S. Pat. No. 6,533,416 “Contact or intraocular lens and method for its preparation”;
U.S. Pat. No. 4,861,152 “Contact lens having at least one aspherical, progressive multifocal face, process for the preparation thereof and use of this contact lens as an intra-ocular implant to be substituted for the eye crystalline lens”.

It is often recognized that spherical aberration extends depth of field and therefore can improve the visual performance for presbyopic patients (see for example WO03032825), but this concept is purely theoretical, it is applicable to positive and negative spherical aberration and it does not lead to a specific lens design. Main target is to eliminate the spherical aberration (see for example http://www.bausch.com/en_US/ecp/visioncare/product/purevision_aberration.aspx).

Every contact or intraocular lens having spherical surfaces exhibits positive spherical aberration in OSA notation, but it does not improve the depth of field of the presbyopic patient.

Some progressive power contact lenses or intraocular lenses have power radially increasing in positive direction, whilst negative spherically aberrated lenses have power radially decreasing.

Patent WO2004052253 relates to a method of controlling an excimer laser unit for performing corneal ablation and inducing negative spherical aberration. This patent refers to a small range of fourth order spherical aberration only and it takes into account the biological response of the cornea and the residual accomodation of the eye.

As is known, lenses are produced by machining blanks on a machine tool driven by an electronic computer to reproduce the desired geometric shape on the blank.

Machine tool instructions are expressed in terms of geometric quantities of the lens being produced, e.g. in terms of vertex power as a function of the distance from the centre of the lens.

The known artificial lenses and relative production methods referred to above have various drawbacks.

In particular, with multifocal lenses, vision acuity, near sight quality at the expense of long sight quality, and vice versa, and performance in poor lighting conditions, are problems which still remain unsolved, and which reduce user tolerance of the lenses.

Also, choosing the right lens for a given subject is not easy. Multifocal contact lenses of various characteristics are available, and are recommended as a function of the basic refractive defect (usually myopia, but also hypermetropia or astigmatism) and to correct near sight. At any rate, to choose the right lens, the subject must normally try various types.

Further drawbacks are encountered in current known methods of designing and fabricating artificial lenses.

In particular, defining optical lens characteristics in geometric terms, such as refractivity as a function of the distance from the centre of the lens, is imprecise and results in the manufacture of imperfect lenses. The lens profile is defined by the vertex power of the individual annular regions (as shown in some of the above patents) connected by a generic gradual variation in vertex power. But there is no precise definition of the profile in mathematical terms.

Moreover, a lens with specific regions for near sight and long sight poses problems, by all the rays striking the pupil being processed simultaneously, regardless of the distance of the object from which the rays originate.

Finally, producing lenses by means of machining processes involves serious difficulties and, therefore, relatively high cost.

### DISCLOSURE OF INVENTION

It is an object of the present invention to provide a lens for correcting presbyopia, designed to eliminate the aforementioned drawbacks of the known art. More specifically, it is an object of the invention to provide an artificial (contact or intraocular) lens for effectively correcting presbyopia, even when associated with refractive defects, and which at the same time provides for a high degree of both short and long vision acuity, even in poor lighting conditions.

It is a further object of the invention to enable troublefree selection and manufacture of the right lens for each subject. More specifically, it is an object of the invention to provide a method of producing artificial lens, which is easy and relatively cheap to implement, and which provides for producing top-quality, precision lenses.

According to the present invention, there are provided an artificial lens, in particular a contact or intraocular lens, for correcting presbyopia, possibly associated with other visual defects, and a relative production method, as claimed in Claims 1 and 6 respectively.

### BRIEF DESCRIPTION OF THE DRAWINGS

A number of non-limiting embodiments of the invention will be described by way of example with reference to the accompanying drawings, in which:

FIG. 1 shows a schematic cross section of an artificial lens in accordance with the invention;

FIG. 2 shows, schematically, the profile of a lens in accordance with the invention compared with a reference lens;

FIG. 3 shows, schematically, the profile of a lens in accordance with the invention, together with a graph showing the curvature of the profile;

FIG. 4 shows, schematically, the profiles of two lenses in accordance with the invention and of different spherical aberration values, together with graphs showing the respective curvatures.

### BEST MODE FOR CARRYING OUT THE INVENTION

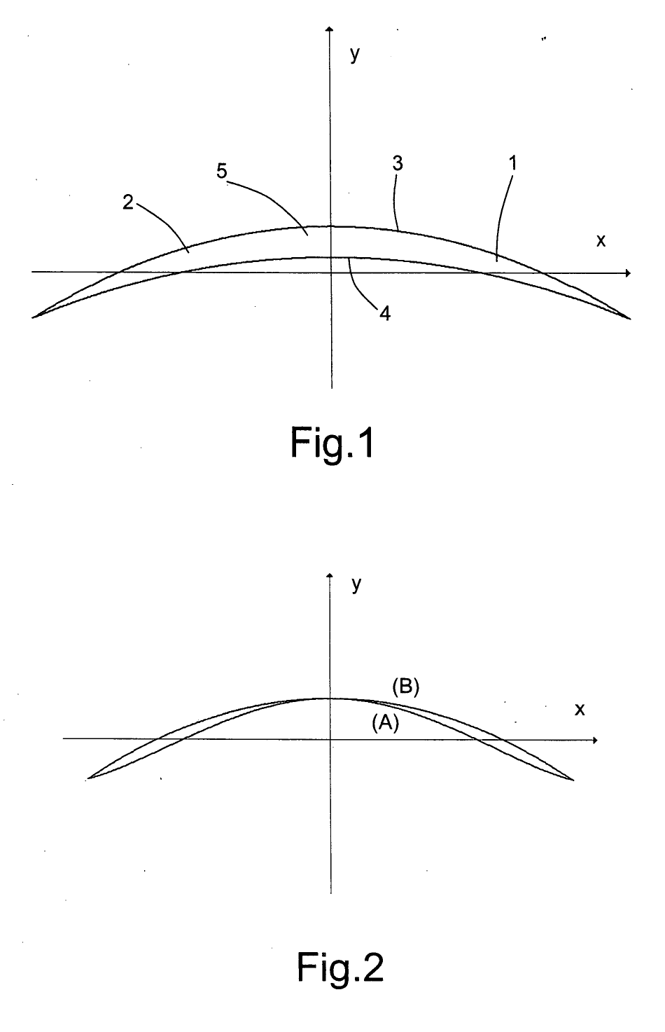

Number 1 in FIG. 1 indicates as a whole an artificial lens for correcting presbyopia, possibly associated with other refractive visual defects (myopia, hypermetropia, astigmatism).

Lens 1 is substantially circular, and is shown in a Cartesian reference system with the x and y axis origin at the geometric centre of the lens; the x and y axes indicate a radial and axial direction respectively.

Lens 1 is a contact lens or intraocular lens, and comprises a substantially known disk-shaped, generally concave/convex base body 2; a convex anterior surface 3 facing outwards of the eye in use; and a concave, flat, or convex posterior surface 4 facing inwards of the eye in use (and resting on the cornea, in the case of a contact lens). In the following description, the characteristics of lens 1 are described in terms of geometric parameters, in particular vertex power, and/or by means of optical parameters (optical aberrations). More specifically, the characteristics of lens 1 are expressed in terms of vertex power (measured in diopters) as regards correction of refractive defects, i.e. II-order aberrations, and with Zernike coefficients for the higher orders (in μm in accordance with the OSA system). Malacara equivalent values are added in brackets.

As is known, refractive defects of the eye (myopia, astigmatism, and hypermetropia) can be measured using aberrometric techniques, i.e. by determining deviations in form of a wavefront with respect to a geometrically perfect reference form. Aberrations of the eye are assumed to be deviations of the wavefront issuing from the eye with respect to a flat wavefront.

In ophthalmology, aberrations are commonly measured using Zernike polynomials, which give a mathematical representation of the aberrant wavefront as the sum of coefficient-weighted elementary functions, i.e. geometrical figures expressed as (x, y) function polynomials.

With Zernike polynomial coefficients, the wavefront on the pupil can be represented by the sum:

$$WR ( x , y ) = {\sum }_{n = 0} {\sum }_{m = 0} {c}_{nm} {Z}_{nm} ( x , y )$$

where: Zₙₘ are the Zernike polynomials, and cₙₘ are the respective reconstruction coefficients which weight each specific Zernike term. The coefficients are expressed in μm, and numbers n and m characterize each polynomial.

The degree to which the reconstructed wavefront WR(x, y) approximates the real wavefront increases alongside an increase in the order n considered in the series.

In ophthalmology, Zernike terms are usually indicated by the notation Cₙ^{v}, which shows the contributing frequencies directly. The exponent is correlated simply with n and m by v=2m−n.

Aberrometry permits measurement of the two basic values used in ophthalmology to measure II-order refractive defects: the sphere S and the cylinder C, which are expressed in diopters. As is known:
hypermetropia is measured by the positive“sphere”parameter;
myopia is measured by the negative“sphere”parameter;
astigmatism is measured by the“cylinder”parameter value of other than zero.

Though widely used in the study of visual defects, and of valuable assistance in corrective surgery, aberrometric techniques are not employed in the design and manufacture of artificial lenses. More specifically, the importance of higher than II-order aberrations in the manufacture of contact and intraocular lenses specifically designed to reduce presbyopia has not yet been acknowledged. On the contrary, known lenses normally have no spherical aberration, on the grounds that artificial-lens manufacturing methods almost invariably interpret spherical aberration as a defect to be reduced or avoided.

To correct presbyopia, the present invention, on the other hand, proposes employing an artificial lens having a IV-order aberration, and in particular a spherical aberration.

Spherical aberration is normally represented by the IV order Zernike coefficient C₄⁰ and can be positive or negative. According to OSA notation negative spherical aberration brings the paraxial focus in between the cornea and the least confusion circle, whilst positive spherical aberration brings the least confusion circle in between the cornea and paraxial focus.

C₄⁰ represents the primary spherical aberration. C₆⁰ and C₈⁰, VI and VIII order Zernike coefficients, represent also spherical aberrations: C₆⁰ represents the secondary spherical aberration and C₈⁰represents the tertiary spherical aberration.

All spherical aberrations are assosymmetric, are centered on the optical axis of the lens and are extended over the full optical zone of the lens. Secondary and tertiary spherical aberrations are essential to improve the acuity of the near vision combined with a good far vision.

The total spherical aberration is represented for the scope of this invention by a combination of C₄⁰, C₆⁰ and C₈⁰.

The invention teaches the ranges of values of each spherical aberration and the total value of C₄⁰+C₆⁰+C₈⁰.

In accordance with the invention, therefore, lens 1 comprises at least one region 5 having a IV-order aberration—more specifically, a spherical aberration (therefore weighted by coefficient C₄⁰) greater than −1.5 μm and less than zero μm (Malacara: greater than zero and less than 3.5 μm).

In addition, lens 1 also has II-order aberrations, i.e. of the cylinder and sphere, to correct refractive defects (myopia, hypermetropia, astigmatism). More specifically, depending on the type of refractive defect of the subject in question, lens 1 has a positive or negative basic vertex power associated with the spherical aberration.

If the subject is astigmatic, lens 1 has a cylindrical basic vertex power to correct astigmatism.

The lens also has fourth- and higher-order aberrations (e.g. VI-order, VIII-order, etc.) to improve the vision acuity of the subject. Combining an increase in spherical aberration with treatment of higher—order aberrations, in fact, has been found to produce a significant improvement in short vision of longsighted subjects.

More specifically the lens has secondary spherical aberration weighted by Zernike C₆⁰ polynomial coefficient in OSA notation such as:
C₆⁰ is greater than −1.0 μm and less than +0.μm
the absolute value of C₆⁰ is lower than the absolute value of C₄⁰
the algebraic sum of C₄⁰+C₆⁰ is greater than −1.5 μm and less than zero μm.

Furthermore the lens has tertiary spherical aberration weighted by the Zernike C₈⁰ polynomial coefficient in OSA notation such as:
the absolute value of C₈⁰ is lower or equal to 10% of the absolute value of C₄ ⁰
the algebraic sum Of C₄⁰+C₆ ⁰ +C₈⁰ is greater than −1.5 μm and less than zero μm.

In other words, depending on the defects of the subject, the lens has specific characteristics, as shown schematically in the following Table:

| | | lens characteristics | |
|---|---|---|---|
| | visual defects of | | High order |
| | subject | II-order aberrations | aberrations |
| A | presbyopia | positive basic vertex | negative spherical |
| | | power | aberration |
| B | myopia-presbyopia | negative vertex power | negative spherical |
| | | to correct myopia | aberration |
| C | hypermetropia- | positive vertex power | negative spherical |
| | presbyopia | to correct presbyopia | aberration |
| D | astigmatism (in | cylinder for correcting | negative spherical |
| | addition to defects | astigmatism (in addition | aberration |
| | A, B, C) | to correction for defects | |
| | | A, B, C) | |

(Malacara: positive spherical aberration)

FIG. 2 shows, schematically, the profile (curve A) of negative-spherical-aberration lens 1, as compared with the profile (curve B) of a reference lens. The reference lens with profile B is a spherical lens with a constant basic vertex power corresponding to the inverse of the radius of curvature. Being a negative-spherical-aberration lens, the radius of curvature of lens 1 with profile A, on the other hand, changes point by point.

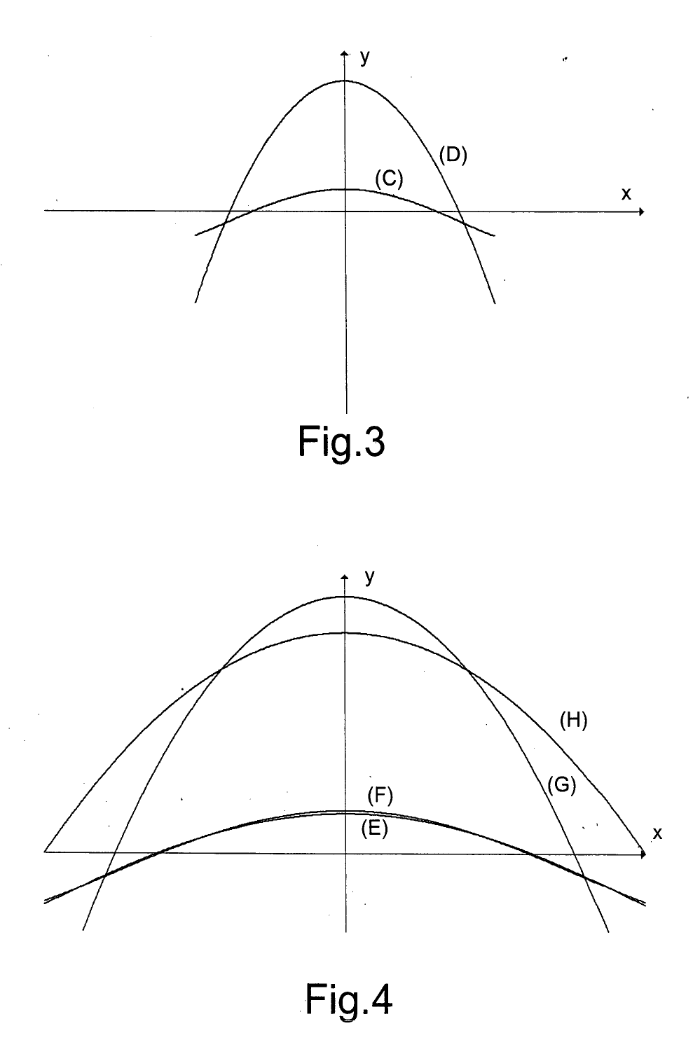

FIG. 3 shows, schematically, the profile C of a further lens in accordance with the invention, having a negative (Malacara: positive) spherical aberration of a different value from the FIG. 2 lens with profile A. FIG. 3 also shows a graph (curve D) of the curvature of profile C; the curvature of profile C is directly related to vertex power, which varies, i.e. decreases, with the distance from the centre point of the lens. The curvature pattern, and therefore also that of the equivalent vertex power, is proportional to the square of the distance. The curvature may also change sign at the ends (i.e. towards the peripheral edge) of the lens.

FIG. 4 shows, schematically, the profiles E, F of a further two lenses in accordance with the invention, and of different spherical aberration values. More specifically, the lens with profile F has a slightly more negative spherical aberration in OSA notation (Malacara: greater positive) than the lens with profile E. FIG. 4 also shows graphs of the curvatures of profiles E, F (curves H, G respectively). As can be seen, curve H (profile E curvature) differs considerably from curve G (profile F curvature), despite the close similarity of profiles E, F, thus showing the importance of lens profile precision: despite the close similarity of the profiles, the lenses differ considerably. Only with the profile described in the present invention can the desired quality and effectiveness of the lens be achieved. Precision is also essential not only in design but also in manufacture of the lens.

Lens 1 according to the present invention is produced using the following method.

The defect/s to be corrected by lens 1 is/are first determined. This is advantageously done by aberrometric analysis.

More specifically, eye performance is acquired and diagnosed using a known aberrometer with a Shack-Hartmann wavefront sensor, e.g. of the type known in medical circles as a WASCA, which makes a complete analysis of the refractive path of light inside the eye.

On the basis of this analysis, a photoablative pattern to be reproduced on lens 1 is determined, and substantially based on the characteristics shown in the foregoing Table. More specifically, the photoablative pattern comprises a negative spherical aberration in OSA notation to correct presbyopia, possibly associated with a given vertex power to correct myopia or presbyopia, and with cylinder correction in the event of astigmatism. Moreover, since, as stated, combining a spherical aberration with higher-order aberration treatment produces a significant improvement in near sight of a longsighted subject, the photoablative pattern is further modified to also induce fourth-and higher-order aberrations (e.g. VI-order, VIII-order, etc.).

The desired photoablative pattern is set on the control unit of a laser device (e.g. an excimer laser device of the type commonly used in refractive surgery of the cornea); the photoablative pattern is expressed in diopters and/or Zernike polynomial coefficients; and the laser device control unit is appropriately connected directly to the aberrometer by which the eye was analyzed.

A substantially disk-shaped base body, made of transparent material suitable for producing contact and intraocular lenses, is then prepared. The base body is a substantially disk-shaped blank, i.e. a disk with substantially no specific optical characteristics.

The method then comprises an ablation step, wherein a surface of the base body is ablated by the laser device, governed by the control unit according to the set photoablative pattern, to induce the desired spherical aberration.

If the subject also suffers from refractive defects, the method comprises an additional-ablation step, wherein the laser device further ablates the surface of the lens to achieve additional vertex power associated with the spherical aberration and for correcting the refractive defects. Additional ablation may be performed separately, either before or after, ablation to induce spherical aberration (bearing in mind that the two ablations may interfere with each other), or may be performed simultaneously in the same step as ablation to induce spherical aberration (in other words, the control unit governs the laser device to simultaneously perform both ablations, for inducing spherical aberration and for correcting refractive defects).

In one variation, the base body is a lens, however manufactured, with a predetermined initial vertex power. More specifically, the base body is a lens for correcting refractive defects (e.g. a commercial contact or intraocular lens), and having a predetermined initial vertex power for correcting myopia, hypermetropia and/or astigmatism, but with substantially no higher than second-order aberrations.

In this case, the method according to the invention provides simply for ablation to induce spherical aberration (and possibly IV- and higher-order aberrations).

As will be clear from the foregoing description, the present invention also provides for greatly simplifying prescription (not only manufacture) of artificial (contact or intraocular) lenses for presbyopics.

Prescription, in fact, is based on the following criteria:
presbyopics are prescribed an artificial lens with: negative (Malacara: positive) spherical aberration and positive vertex power;
presbyopics-myopics are prescribed an artificial lens with: negative spherical aberration in OSA notation and negative vertex power;
presbyopics-hypermetropics are prescribed an artificial lens with: negative spherical aberration in OSA notation and positive vertex power.

Whichever the case, spherical aberration is prescribed to achieve a total spherical aberration of the eye-artificial lens system of −0.9 μm to zero μm in OSA notation (Malacara: zero to +2.0 μm).

In other words, in the case of a contact lens: the best corrected vision acuity (BCVA) and spherical aberration of the eye are measured; an aberrant artificial lens is selected to achieve the desired total spherical aberration (−0.7 μm to zero μm) (Malacara: zero to 1.5 μm) of the eye-artificial lens system; the contact lens is applied, and aberration measured to ensure the applied lens actually achieves the desired refractive characteristics.

Similarly, in the case of an intraocular lens in cataract-free presbyopic subjects: the BCVA and spherical aberration of the eye are measured; an aberrant contact lens is selected to achieve the desired total spherical aberration of the eye-lens system; the contact lens is applied to the subject and tested to ensure the lens applied to the eye actually achieves good vision; if necessary, other contact lenses are applied and tested until the solution best suited to the subject is found; and, finally, the intraocular lens corresponding to the best contact lens is applied.

In the case of subjects with cataracts, the vertex power of the artificial crystalline lens is calculated, and spherical aberration induced to achieve a total spherical aberration of −0.9 μm to zero μm in OSA notation (Malacara: zero to +2.0 μm).

The advantages of the present invention, as compared with known artificial lenses and production methods, will be clear from the foregoing description.

The lens according to the invention, be it a contact or intraocular lens, provides for effectively correcting presbyopia, even when associated with refractive defects, and for achieving a high degree of both short and long vision acuity, even in poor lighting conditions.

The production method according to the invention is straightforward and relatively cheap to implement, and provides for high-quality, high-precision lenses.

More specifically, by means of appropriate control, the present invention employs the same excimer laser device heretofore employed in refractive surgery.

The method according to the invention provides for producing much more precise contact and intraocular lenses than known methods, particularly those based on defining the lens profile in the form of concentric optical regions (which result in artificial lenses with discontinuous or approximate profiles, and which, above all, are difficult to produce).

The invention also provides for simplifying and more accurately prescribing and/or selecting the best lens for each subject.

Clearly, changes may be made to what is described and illustrated herein without, however, departing from the scope of the present invention, as defined in the accompanying Claims.

1) An artificial lens, in particular a contact lens or intraocular lens, for correcting presbyopia, possibly associated with other visual defects, and characterized by having a fourth-order spherical aberration represented by the Zernike C₄⁰ polynomial coefficient in OSA notation of greater than −1.5 μm and less than zero μm (Malacara: greater than zero and less than 3.5 μm).

2) A lens according to claim 1, characterized by having secondary spherical aberration represented by Zernike C₆⁰ polynomial coefficient in OSA notation in the range of −1.0 μm to +0.1 μm, being the absolute value of C₆⁰ lower or equal to the absolute value of C₄⁰ and being the sum of C₄⁰+C₆⁰ greater than −1.5 μm and less than zero μm.

3) A lens according to claim 1, characterized by having tertiary spherical aberration represented by the Zernike C₈⁰ polynomial coefficient in OSA notation such as the absolute value of C₈⁰ is lower or equal to 10% of the absolute value of C₄⁰, being the sum of C₄⁰+C₆⁰+C₈⁰ greater than −1.5 μm and less than zero μm.

4) A lens according to claim 1, characterized by having a positive or negative basic vertex power associated with said fourth-order aberration to correct refractive defects.

5) A lens according to claim 1, characterized by having a cylindrical basic vertex power to correct astigmatism.

6) A method of producing artificial lenses according to claim 1 for correcting presbyopia, the method being characterized by comprising the steps of:
a) preparing a base body of a lens made of transparent material;
b) ablating, by means of a laser device, a surface of the base body according to a given photoablative pattern, wherein the laser is adapted to induce a fourth, sixth and eighth order spherical aberrations.

7) A method according to claim 6, characterized by comprising a step of setting, on a control unit of the laser device, the photoablative pattern to be reproduced on the base body; the laser device being controlled by the control unit in terms of diopters and/or Zernike polynomial coefficients.

8) A method according to claim 6, characterized by comprising a step of ablating said surface of the artificial lens by means of said laser device to achieve an additional vertex power associated with the spherical aberration and for correcting refractive defects.

9) A method according to claim 6, characterized in that the base body is a substantially disk-shaped blank.

10) A method according to claim 6, characterized in that the base body has a predetermined initial vertex power.

11) A method according to claim 6, characterized in that the base body is a lens for correcting refractive defects, having a predetermined initial vertex power for correcting myopia, hypermetropia and/or astigmatism, and having substantially no higher than second-order aberrations.

12) A method of prescribing an artificial lens, in particular a contact lens or intraocular lens, for a presbyopic subject, characterized by comprising the operations of :
prescribing a lens with negative spherical aberration in OSA notation and positive vertex power, in the case of an exclusively presbyopic subject;
prescribing a lens with negative spherical aberration in OSA notation and negative vertex power, in the case of a presbyopic-myopic subject;
prescribing a lens with negative spherical aberration in OSA notation and positive vertex power, in the case of a presbyopic-hypermetropic subject.

13) A method of prescribing an artificial lens, in particular a contact lens or intraocular lens, for a presbyopic subject, characterized in that a lens is prescribed with such a spherical aberration that the total spherical aberration of the system defined by the subject's eye and the artificial lens ranges between zero and roughly 2 μm.

14) A method according to claim 13 characterized by comprising the steps of:
a) measuring the best corrected vision acuity (BCVA) of the subject's eye;
b) measuring spherical aberration of the subject's eye;
c) selecting an aberrant artificial lens to achieve the predetermined total spherical aberration of the system defined by the subject's eye and the artificial lens;
d) applying the lens, and determining, by aberration measurement, that the lens applied to the eye actually achieves the desired refractive characteristics.

15) A method according to claim 13, characterized by comprising the steps of:
a) measuring the best corrected vision acuity (BCVA) of the subject's eye;
b) measuring spherical aberration of the subject's eye;
c) selecting an aberrant contact lens to achieve the predetermined total spherical aberration of the system defined by the subject's eye and the contact lens;
d) applying the contact lens to the eye, and determining whether the lens provides for achieving satisfactory vision;
e) possibly applying different contact lenses of different characteristics, and selecting the lens which provides for best vision;
f) applying an intraocular lens corresponding to the selected contact lens.
